(19) United States
(12) Patent Application Publication
(10) Pub. No.: US 2025/0371393 A1
(43) Pub. Date: Dec. 4, 2025

(54) CAUSAL DISCOVERY USING KNOWLEDGE GRAPH LINK PREDICTION

(71) Applicant: Robert Bosch GmbH, Stuttgart (DE)

(72) Inventors: Cory HENSON, Pittsburgh, PA (US); Utkarshani JAIMINI, West Columbia, SC (US)

(21) Appl. No.: 18/675,768

(22) Filed: May 28, 2024

(51) Int. Cl. G06N 7/01; G06N 20/00

(52) U.S. Cl. CPC G06N 7/01; G06N 20/00

(57) ABSTRACT

Causal discovery is performed using knowledge graph link prediction. Information from a causal network is transformed into a causal knowledge graph according to a mapping, the causal knowledge graph including a plurality of causal links, wherein each causal link includes a cause entity, a causal relation, an effect entity, and a causal weight indicating a relative strength of causal influence of the cause entity on the effect entity. The causal knowledge graph is converted into embeddings, where the embeddings include a latent vector space representation of the causal knowledge graph. The embeddings are trained using a subset of the causal links of the causal knowledge graph. The embeddings are used for causal discovery to predict additional causal links of the causal knowledge graph.

### TECHNICAL FIELD

Aspects of the disclosure generally relate to causal discovery using knowledge graph link prediction.

### BACKGROUND

A knowledge graph is a graphical data model which captures semantic relationships between entities, where the entities may be events, objects, or concepts. The knowledge graph may be used to capture causality in terms of cause and effect. Such an entity-based representation model enables broader search space by linking a causal entity to relevant effect entities or concepts in the knowledge graph.

### SUMMARY

In one or more illustrative examples, causal discovery is performed using knowledge graph link prediction. Information from a causal network is transformed into a causal knowledge graph according to a mapping, where the causal knowledge graph includes a plurality of causal links, each of the causal links includes a cause entity, a causes relation, an effect entity, and a causal weight indicating a relative strength of causal influence of the cause entity on the effect entity. The causal knowledge graph is converted into embeddings, where the embeddings include a latent vector space representation of the causal knowledge graph. The embeddings are trained using a subset of the causal links of the causal knowledge graph. The embeddings are used for causal discovery to predict additional causal links of the causal knowledge graph.

In one or more illustrative examples, the mapping includes mapping causal weights in the causal network to causal weights in the causal knowledge graph.

In one or more illustrative examples, the translating is performed conformant to a causal ontology, the causal ontology defining concepts to structure the causal knowledge graph.

In one or more illustrative examples, the mapping further includes mapping nodes in the causal network into causal entities in the causal knowledge graph; and mapping edges in the causal network into causal links in the causal knowledge graph.

In one or more illustrative examples, the method includes removing causal links from the causal knowledge graph having causal weights below a predefined minimum threshold of causal weight.

In one or more illustrative examples, a causal event graph is used as proxy for the causal network, and further comprising, when translating the information into the causal knowledge graph, removing cycles from the causal event graph.

In one or more illustrative examples, wherein the causal graph has a depth of greater than or equal to two nodes from root to leaf node, and the method further includes performing a Markov-based data split between the train and test sets.

In one or more illustrative examples, the causal discovery includes casual explanation to predict, given an effect entity, a type of a cause entity of the additional causal link.

In one or more illustrative examples, the causal discovery includes casual prediction to predict, given a cause entity, a type of an effect entity of the additional causal link.

In one or more illustrative examples, a system for causal discovery using knowledge graph link prediction includes one or more hardware computing devices configured to translate information from a causal network into a causal knowledge graph according to a mapping, the causal knowledge graph comprising a plurality of causal links, wherein each of the causal links includes a cause entity, a causes relation, an effect entity, and a causal weight indicating a relative strength of causal influence of the cause entity on the effect entity; convert the causal knowledge graph into embeddings, the embeddings comprising a latent vector space representation of the causal knowledge graph; train the embeddings using a subset of the causal links of the causal knowledge graph; and use the embeddings for causal discovery to predict additional causal links of the causal knowledge graph.

In one or more illustrative examples, the mapping includes mapping causal weights in the causal network to causal weights in the causal knowledge graph.

In one or more illustrative examples, the translating is performed conformant to a causal ontology, the causal ontology defining concepts to structure the causal knowledge graph.

In one or more illustrative examples, the one or more hardware computing devices are further configured to map nodes in the causal network into causal entities in the causal knowledge graph; and map edges in the causal network into causal links in the causal knowledge graph.

In one or more illustrative examples, the one or more hardware computing devices are further configured to remove causal links from the causal knowledge graph having causal weights below a predefined minimum threshold of causal weight.

In one or more illustrative examples, a causal event graph is used as proxy for the causal network, and further comprising, when translating the information into the causal knowledge graph, removing cycles from the causal event graph.

In one or more illustrative examples, the causal graph has a depth of greater than or equal to two nodes from root to leaf node, and the one or more hardware computing devices are further configured to perform a Markov-based data split between the train and test sets.

In one or more illustrative examples, the causal discovery includes casual explanation to predict, given an effect entity, a type of a cause entity of the additional causal link.

In one or more illustrative examples, the causal discovery includes casual prediction to predict, given a cause entity, a type of an effect entity of the additional causal link.

In one or more illustrative examples, a non-transitory computer-readable medium includes instructions for causal discovery using knowledge graph link prediction that, when executed by one or more computing devices, cause the one or more computing devices to perform operations including to translate information from a causal network into a causal knowledge graph according to a mapping, wherein the causal knowledge graph comprising a plurality of causal links, each of the causal links includes a cause entity, a causes relation, an effect entity, and a causal weight indicating a relative strength of causal influence of the cause entity on the effect entity, the mapping including mapping causal weights in the causal network to causal weights in the causal knowledge graph; convert the causal knowledge graph into embeddings, the embeddings comprising a latent vector space representation of the causal knowledge graph; train the embeddings using a subset of the causal links of the causal knowledge graph; and use the embeddings for causal discovery to predict additional causal links of the causal knowledge graph.

In one or more illustrative examples, the causal discovery includes one or more of casual explanation to predict, given an effect entity, a type of a cause entity of the additional causal link; and causal discovery includes casual prediction to predict, given a cause entity, a type of an effect entity of the additional causal link.

### BRIEF DESCRIPTION OF THE DRAWINGS

FIG. 1A illustrates an example snapshot of a relationship between entities at a first time;

FIG. 1B illustrates an example snapshot of a relationship between entities at a second time after the first time;

FIG. 1C illustrates an example snapshot of a relationship between entities at a third time after the second time;

FIG. 2 illustrates a flow diagram of the four phases of disclosed approach to causal discovery using knowledge graph link prediction;

FIG. 3 illustrates an example of a reified causal relations;

FIG. 4 illustrates an example causal event graph (CEG) based on CLEVRER-Humans;

FIG. 5 illustrates an example table of causal links;

FIG. 6A illustrates an example CausalKG structure including a subgraph C with causal links with only causal relations;

FIG. 6B illustrates an example CausalKG structure including a subgraph CT with causal links with causal relations and information about entity types;

FIG. 6C illustrates an example CausalKG structure including a subgraph CTP with causal relations, entity type relations, and information about the objects that participate in the causal events;

FIG. 7A illustrates an example evaluation of CausalKGE-Base vs CausalKGE-W for causal explanation with a random data split;

FIG. 7B illustrates an example evaluation of CausalKGE-Base vs CausalKGE-W for causal prediction with a random data split;

FIG. 7C illustrates an example evaluation of CausalKGE-Base vs CausalKGE-W for causal explanation with a Markov-based data split;

FIG. 7D illustrates an example evaluation of CausalKGE-Base vs CausalKGE-W for causal prediction with a Markov-based data split;

FIG. 8A illustrates an example evaluation of CausalKGE-Base for causal explanation with a random vs a Markov-based data split;

FIG. 8B illustrates an example evaluation of CausalKGE-W for causal explanation with a random vs a Markov-based data split;

FIG. 8C illustrates an example evaluation of CausalKGE-Base for causal prediction with a random vs a Markov-based data split;

FIG. 8D illustrates an example evaluation of CausalKGE-Base for causal prediction with a random vs a Markov-based data split;

FIG. 9 illustrates an example process for causal discovery using knowledge graph link prediction; and

FIG. 10 illustrates an example manufacturing system for use in performing causal discovery using knowledge graph link prediction; and

FIG. 11 depicts a schematic diagram of a control system configured to control a robotic assistant based on the causal discovery.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Causal discovery is a process of discovering new causal relations from observational data. Causal discovery is defined as the process of finding new causal relations by analyzing observational data. The newly discovered causal relations are encoded as a causal network with edges representing the causal links between entities. Each causal link may also be annotated with weights representing the strength of the causal connection.

Causal discovery algorithms fall under two major categories: constraint-based and score-based approaches. The constraint-based approaches use conditional independence relations in the observational data to find Markov equivalence classes of directed causal structures. The score-based methods use structural equation models to find unique causal structures under certain assumptions. Another approach to causal discovery, the knowledge guided greedy score-based approach, uses prior knowledge about the causal structure (knowledge about the edges, i.e., presence or absence of a directed or an un-directed edge) between entities and observational data to learn causal graphs.

Traditional causal discovery techniques often use interventional experiments that are time-consuming and expensive due to the inherently large search spaces involved. They also rely solely on the use of observation data with datasets that are often incomplete and lack important information about the underlying causal structures, leading to an incomplete causal network. If the incomplete causal network is encoded as a knowledge graph (KG), then the task of causal discovery can be formulated as a knowledge graph completion problem, i.e., finding missing links in the graph.

To address these issues, this disclosure formulates causal discovery as a knowledge graph completion problem. More specifically, the task of discovering causal relations is mapped to the task of knowledge graph link prediction. This allows for two types of discovery: causal explanation and causal prediction. The causal relations have weights representing the strength of the causal association between entities in the knowledge graph. An evaluation of this approach uses a benchmark dataset of simulated videos for causal reasoning, CLEVRER-Humans, and compares the performance of multiple knowledge graph embedding algorithms. In addition, two distinct dataset splitting approaches are utilized within the evaluation: (1) random-based split, which is the method typically used to evaluate link prediction algorithms, and (2) Markov-based split, a novel data split technique for evaluating link prediction that utilizes the Markovian property of the causal relation. Results show that using weighted causal relations improves causal discovery over the baseline without weighted relations.

Aspects of the disclosure relate to an approach to discovering causal relations using KG link prediction methods. This approach includes of four primary phases: (1) encoding known causal relations into a causal network, (2) translating the causal network into a knowledge graph, (3) learning knowledge graph embedding for the causal relations, and (4) predicting new causal links in the knowledge graph.

In a knowledge graph, causal relations may be encoded as triples of the form <cause-entity, causes, effect-entity, w> with the causes predicate linking the cause-and-effect entities. Each causes relation is associated with a causal weight, w, that represents the causal influence of the cause-entity on the effect-entity. This causal influence is measured by performing an intervention on the cause-entity and observing its outcome on the effect-entity.

In the next phase, a KG embedding model is learned. Any KGE algorithm may be used for this task. However, current algorithms do not incorporate weights relations into the learned embedding model. To overcome this issue, FocusE is used to assimilate the causal weight into the KGE model.

In the final phase, KG link prediction is used to discover new causal relations. More specifically, two causal discovery tasks are performed: causal explanation and causal prediction. When implemented with link prediction, causal explanation is mapped to the task of finding the type of the head (i.e., a cause-entity) of a causal link, and causal prediction is mapped to the task of finding the type of the tail (i.e. an effect-entity) of a causal link.

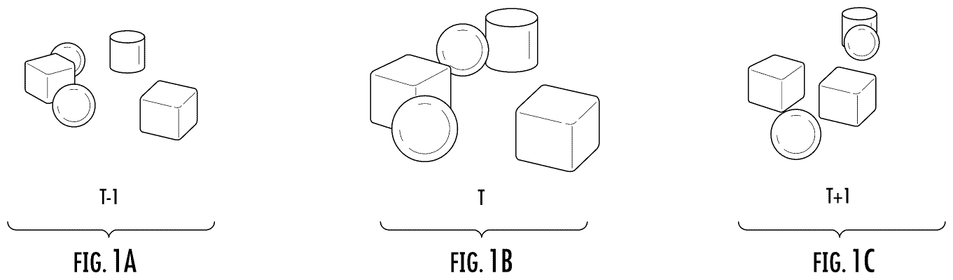

FIGS. 1A-1C collectively illustrate an example snapshot of collision events in a video at times t−1, t, and t+1. FIG. 1A illustrates an example of the collision events at time t−1, FIG. 1B illustrates an example scene at time t, and FIG. 1C illustrates an example scene at time t+1. In the sequence, there are four consecutive collision events that occur: 1) the red cube enters from the left, 2) the red cube collides with the yellow ball, 3) the yellow ball hits the blue cylinder, and 4) the blue cylinder moves.

The events occurring in these three video frames can be encoded as triples in a causal KG. The triple may indicate a cause-and-effect relationship. As shown in FIG. 1A, at time t−1 <the red cube enters from the left, causes, the red cube collides with the yellow ball>. As shown in FIG. 1B, this subsequently leads to time t where <the red cube collides with the yellow ball, causes, the yellow ball hit with the blue cylinder>. Then, as shown at Eventually this leads to t+1 where <the yellow ball hits the blue cylinder, causes, the blue cylinder to move>.

This information may be used to consider a causal explanation query: Explain the cause of the event the red cube colliding with the yellow ball which occurs at t. The answer would be a prior event the red cube enters from the left which occurs at t−1. Similarly, the information may be used to consider the causal prediction query: Predict the effect of the event the red cube colliding with the yellow ball which occurs at t. The answer would be a subsequent event the blue cylinder moves which occurs at t+1. From this example, it can be seen that the answer to a causal explanation query requires predicting a causal relation to prior events, and the answer to a causal prediction query requires predicting a causal relation to subsequent events.

With the traditional approach to evaluating KG embedding algorithms, triples are randomly split into a train and test set. In the case of a causal KG, such an approach could lead to model bias. This is due to the fact that there may be multiple causal relations connecting a cause and effect entity in the KG. To resolve this issue, a Markov-based split may be performed that is based on the local Markov property of the causal triples.

Causal discovery may be formulated as a KG link prediction problem. This may be defined in terms of causal relations 302, a causal triple, a causal entity 304, a causal weight 306, and the causal knowledge graph 216. Each of these terms is defined as follows:

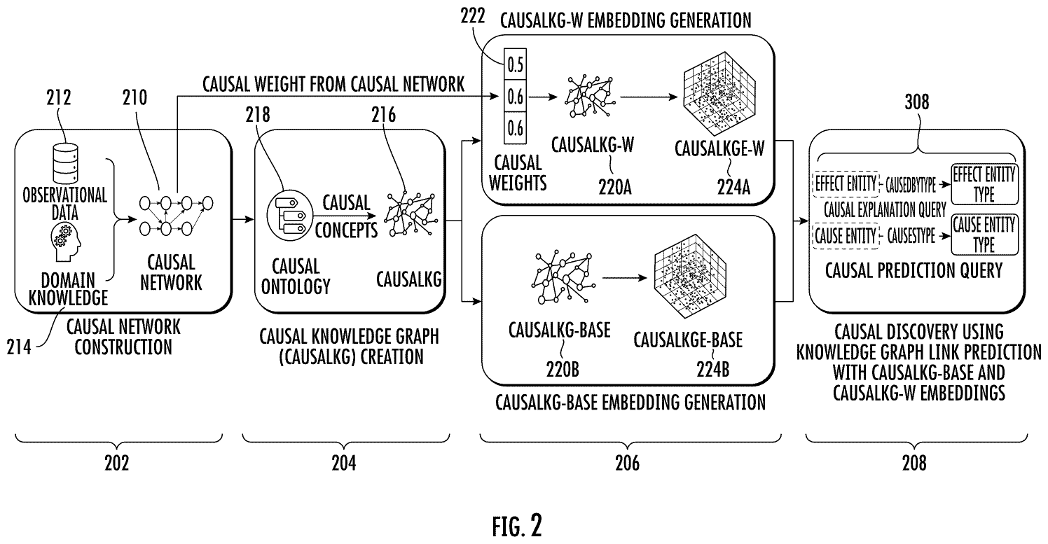

FIG. 2 illustrates a flow diagram of the four phases of disclosed approach to causal discovery using knowledge graph link prediction. These four primary phases are: causal network construction 202, causal knowledge graph creation 204, embedding learning 206, and causal discovery 208. The causal network construction 202 may include finding and encoding the known causal relations into a causal network 210. This causal network construction 202 may be performed using observational data 212 and/or using domain knowledge 214. The causal knowledge graph creation 204 may include translating the causal network 210 into a CausalKG 216, conformant to a causal ontology 218. The embedding learning 206 may include learning KG embedding models 220A, 220B for the CausalKG 216. This may be performed in two different approaches. In a first approach, causal weights 306 from the causal network 210 are used in embeddings 224A with causal weights 306 to generate embedding model 220A. In a second approach, the causal weights 306 from the causal network 210 are not used, resulting in embeddings 224B without causal weights 306 to generate embedding model 220B. The causal discovery 206 may include using the knowledge graph embeddings 224A, 224B for causal discovery tasks. One example of such a task is predicting new causal links 308 in the CausalKG 216.

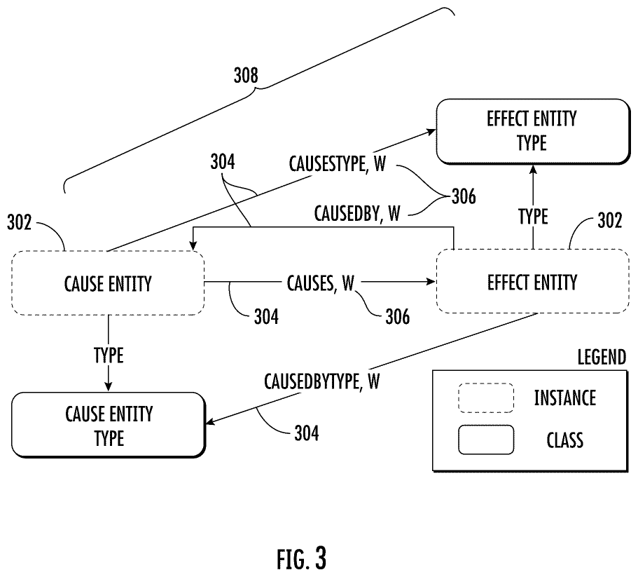

FIG. 3 illustrates an example of reified causal relations. Referring to FIG. 3 and with continued reference to FIG. 2, a CausalKG 216 is a KG that includes causal knowledge in the form of causal entities 302, causal relations 304, and causal weights 306. The causesType is a reified relation from a cause-entity instance to the type of an effect-entity. The causedByType is a reified relation from an effect-entity instance to the type of a cause-entity.

Let CausalKG=(N, R, E, E_{c}, W_{c}), where:
N: a set of nodes representing entities;
R: a set of labels representing relations;
E⊆N×R×N: a set of edges representing links between pairs of entities. Each link is a triple <h, r, t>, where h is the head entity, r is the relation, t is the tail entity;
N_{c}⊆N: a set of nodes representing causal entities 302;
R_{c}⊆R: a set of labels representing causal relations 304;
W_{c}⊆ [symbol] : a set of real numbers representing causal weights 306; and
E_{c}⊆N_{c}×R_{c}×N_{c}×W_{c}: a set of edges representing causal links 308 connecting pairs of causal entities 302. Each causal link 308 is a quad <h_{c}, r_{c}, t_{c}, w_{c}>, where h_{c} is the head causal entity 302, r_{c} is the causal relation 304, t_{c} is the tail causal entity 302, and w_{c} is the causal weight 306.

A causal entity 302, n_{c}∈N_{c}, is an entity that is the head or tail of a causal link 308. There are two types of causal entities 302: cause-entity (n_{cause}) and effect-entity (n_{effect}) such that the cause-entity causes the effect-entity.

A causal relation 304, r_{c}∈R_{c}, is a relation representing a causal association between entities. There are four types of causal relations:
causes (r_{causes}∈R_{c}) is a causal relation from the cause-entity to the effect-entity;
causedBy (r_{causedBy}∈R_{c}) is a causal relation from the effect-entity to the cause-entity; i.e. the inverse of causes;
causesType (r_{causesType}∈R_{c}) is a causal relation from the cause-entity to the type of the effect-entity; and
causedByType (r_{causedByType}∈R_{c}) is a causal relation from the effect-entity to the type of the cause-entity.

A causal weight 306, w∈W_{c}⊆ [symbol] , is a real number associated with a causal link 308. It quantifies the responsibility or contribution of the cause-entity in causing the effect-entity.

A causal link 308, e_{c}∈E_{c}, is an edge in the causal KG 216 connecting a pair of causal entities 302 with a causal relation 304 and an associated causal weight 306. The causal link 308 is a quad <h_{c}, r_{c}, t_{c}, w_{c}>, where he is the head causal entity 302, r_{c} is the causal relation 304, t_{c} is the tail causal entity 302, and w_{c} is the causal weight 306.

Causal discovery is the task of finding new causal links 308 in a CausalKG 216. Given a CausalKG 216, G, this task can be implemented using knowledge graph link prediction. There are two types of causal discovery: causal prediction and causal explanation.

In causal prediction, given a cause-entity (n_{cause}∈N_{c}) and the causesType relation (r_{causesType}∈R_{c}), the object is to find the type (t) of the associated effect-entity such that <n_{cause}, r_{causesType}, t, W_{c}>∈G holds.

In causal explanation, given an effect-entity (n_{effect}∈N_{c}) and the causedByType relation (r_{causedByType}∈R_{c}), find the type (t) of the associated cause-entity such that <n_{effect}, r_{causedByType}, t, W_{c}>∈G holds.

Returning to FIG. 2, the causal network 210 is a graphical model that describes the cause-and-effect relationships between the nodes. The causal network 210 may be represented as a causal Bayesian network. The causal network 210 may be in the form of a directed acyclic graph, where the nodes of the network denote events and the edges represent the causal association between them. Mathematically, this may be written as CN=(N^{cn}, E^{cn}, W^{cn}), such that N^{cn} is the set of nodes in the causal network, E^{cn} is the set of edges between nodes, and W^{cn} is the set of causal weights 306 associated with the edges. The direction of the edge denotes the direction of the causal association.

Each edge has a causal weight 306, w∈W, which measure the strength of the edge between the nodes. The causal weight 306 represents the total causal effect estimated using do-calculus. The total causal effect is the measure of the strength of the change of a given node on its direct linked node. Given an edge, e∈E^{cn}, between two nodes (n₁∈N^{cn}, n₂∈N^{cn}), the total causal effect can be estimated as an expected value (EV) of intervention on n₁ using do-calculus, EV [n₂|do (n₁)]. The causal network 210 satisfies the local Markov property where given the direct causes of a node, it is independent of its non-effects.

The task of translating information from a causal network 210 into a causalKG 216 may be performed according to a mapping. In an example, the following mapping may be performed:
N^{cn}→N_{c}: nodes in the causal network 210 become causal entities in the CausalKG 216;
W^{cn}→W_{c}: causal weights 306 in the causal network 210 become causal weights 306 in the CausalKG 216;
E^{cn}→E_{c}: edges in the causal network 210 become causal links 308 in the CausalKG 216, of the form <n_{cause}, r_{causes}, n_{effect}, w_{c}>

Additional causal links 308 may be added to the CausalKG 216 as appropriate, including those utilizing the other causal relations: causedBy, causesType, and causedByType. The resulting CausalKG 216 contains all the information from the causal network 210 and is conformant to the causal ontology 218.

The causal ontology 218 used for this task defines the structure and semantics of causal relations using the concepts grounded in causal AI, i.e., causal Bayesian network and do-calculus. More specifically, the causal ontology 218 defines the primary concepts used to structure a CausalKG 216, including causal entities 302, causal relations 304, and causal weights 306.

The CausalKG 216 is used for causal discovery using KG link prediction. For the task of causal explanation, the goal is to predict the type of a cause-entity that is linked to an effect-entity and not to predict the specific cause-entity instance. However, the effect-entity does not link directly with the cause-entity type. Rather it is connected through a two-hop path: <n_{effect}, r_{causedBy}, n_{cause}>, <n_{cause}, rdf:type, type>.

KG link prediction models can only make predictions about directly linked entities. To overcome this issue, the CausalKG 216 may use a reified relation causedByType (r_{causedByType}∈R_{c}) to add links 308 connecting an effect-entity with the type of a cause-entity. This is shown in FIG. 3. The same issue arises for the task of causal prediction where the goal is to predict the type of an effect-entity that is linked to a cause-entity. To overcome this issue, the CausalKG 216 may use a reified relation causesType (r_{causesType}∈R_{c}) to add causal links 308 connecting a cause-entity with the type of an effect-entity.

The CausalKG 216 can also integrate additional domain knowledge 214 associated with the causal entities 302 which are not explicitly mentioned in the causal network 210. This domain knowledge 214 may be sourced from various individuals, databases, web queries, or other sources of information.

Regarding CausalKG 216 embedding and link prediction, the CausalKG 216 may be converted into a low-dimensional continuous latent vector space representation, referred to as the KG embeddings 224. The KG embeddings 224 can then be used for downstream tasks such as link prediction, triple classification, entity classification, relation extraction, etc. The disclosed approach uses KG embedding 224 algorithms to generate embeddings 224 that can be used for causal discovery. The disclosed approach learns two types of KG embeddings 224 for a CausalKG 216: 1) where the embeddings 224A are learned without causal weights 306 (referred to herein as CausalKGE-Base), and 2) where the embeddings 224B are learned with causal weights 306 (referred to herein as CausalKGE-W).

The CausalKG-W uses causal weights 306 to generate weighted KGEs 224B. In an example, the CausalKG embeddings for both CausalKGE-Base and CausalKGE-W may be generated using KG embedding algorithms available in the Ampligraph library. The CausalKGE-Base embedding may be trained using the causal links 308 but ignoring the causal weights 306 associated with each causal link 308. The CausalKGE-W embedding, on the other hand, may be trained using the causal links 308 with the causal weights 306. The causal links 308 with high causal weight 306 may have a high probability of being true. The causal links 308 with low causal weight 306 signifies an unlikely causal link 308, and causal links 308 with causal weight 306 of zero are considered as negative samples. During the training, the causal weights 306 may be used to update the output of a scoring layer of a KGE algorithm before feeding the scores to the loss layer. The scores from the scoring layer may be modulated based on the causal weight 306 values associated with the links 308 to obtain weighted scores. The CausalKGE-Base and CausalKGE-W embeddings 224 may be evaluated on the task of causal discovery using KG link prediction techniques.

This approach therefore formalizes the problem of causal discovery as a KG link 308 prediction task. The trained CausalKG embedding models, e.g., CausalKGE-Base and CausalKGE-W, may be used to predict missing causal links 308 between causal entities 302 in the causalKG 216. In some examples, this approach may be used for the tasks of causal explanation and causal prediction. Causal explanation aims to predict the cause of an effect and causal prediction aims to predict the effect of a cause. For a given causal link 308, causal explanation predicts links 208 of form <n_{effect}, r_{causedByType}, ?, w>, and causal prediction predicts links 308 of form <n_{cause}, r_{causesType}, ?, w>.

Given any dataset, with causal relations 304, causal entities 302, and causal weights 306 associated with the causal links 308 between the causal entities 302, the disclosed approach may be used to generate a CausalKG 216 and KG embeddings 224. The generated KG embeddings 224 can then be used for causal discovery in the form of causal explanation and causal prediction. This approach can be demonstrated and evaluated using CLEVRER-Humans, a causal reasoning benchmark dataset.

As shown herein, the disclosed causal discovery approach is evaluated using a KG link 308 prediction task for 1) causal explanation, given an effect-entity predict the type of the cause-entity of the causal link 308 of form <n_{effect}, r_{causedByType}, ?, w>, and 2) causal prediction, given a cause-entity predict the type of effect-entity of the causal triple of form <n_{cause}, r_{causesType}, ?, w>. The results of these predictions may be demonstrated using a benchmark dataset for causal reasoning, CLEVRER-Humans. For sake of example, the CLEVRER-Humans dataset, the data pre-processing steps, the creation of a CausalKG 216 from the dataset, experimental set up, the evaluation metrics, and the description of the evaluation for different CausalKG variations are discussed.

CLEVRER-Humans is a causal reasoning benchmark dataset with human annotated causal judgement regarding physical events occurring in videos. The dataset is based on the videos from CLEVRER, a simulated dataset of collision events for video representation and reasoning. The videos consist of moving objects that are distinct in their shape (sphere, cube, and cylinder), color (blue, red, yellow, green, purple, gray, cyan and brown) and material (metal and rubber). Each object can participate in 27 distinct events such as enter, exit, collide, move, hit, bump, roll etc.

FIGS. 1A-1C discussed above illustrate an example snapshot of events occurring in a CLEVRER video. CLEVRER-Humans encodes the causal information from these events in the form of Causal Event Graph (CEG), where the nodes of the graph are descriptions of events in the videos and the directed edges between the nodes represent the causal links 308.

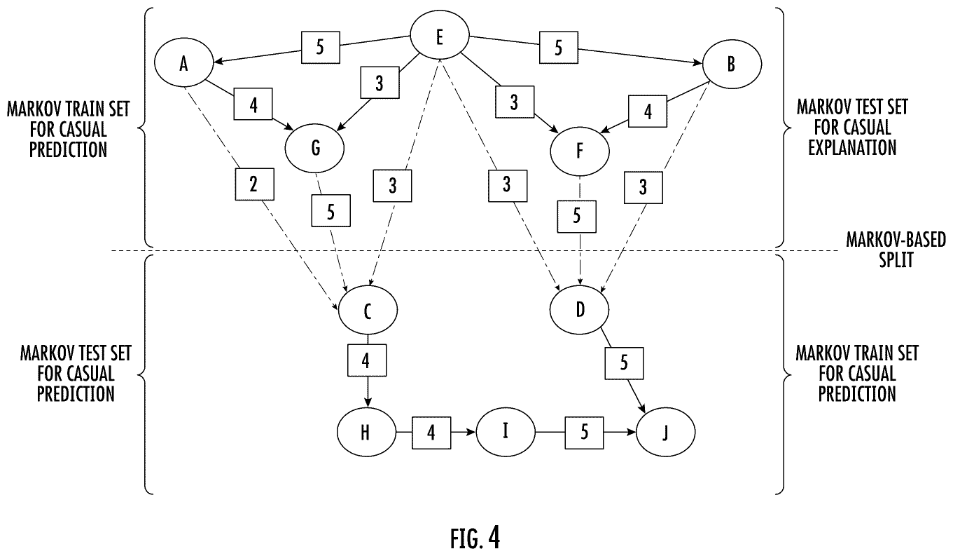

FIG. 4 illustrates an example causal event graph (CEG) based on CLEVRER-Humans. The nodes in the graph represent events in a video and the edges represent causal relations. The edge label is a human annotated score symbolizing the strength of the causal relation. For example, the edge from event E to A represents the fact that event E causes event A. The edge label of 5 represents that event E is extremely responsible for causing event A. The horizontal dotted line exemplifies the Markov-based split.

As shown, the events in the CEG include: event A where a brown cube moves, event B where a purpose sphere slows down, event C where a purple cylinder slides to the right, event D where a gray cube is pushed to the left, event E where a purple ball bumps the brown cube, event F where the purple ball hits the gray cube, event G where the brown cube collides with the purple cylinder, event H where the purple cylinder strikes a red cube, event I where the red cube spins clockwide, and event J where the red cube collides with the gray cube.

The edges of the CEGs are scored by human annotators to determine the strength of causal links 308 between the nodes. The edges are scored between 1-5, such that 1=not responsible at all, 2=a bit responsible, 3=moderately responsible, 4=quite responsible, and 5=extremely responsible.

A first step towards generation of a CLEVRER-Humans CausalKG 216 involves pre-processing the CEGs. Regarding the structure of the CEGs, the CEGs are considered as a proxy for a causal network 210. The pre-processing of the CEGs is done to ensure that they are consistent with the definition of causal network 210. The edges in the causal network 210 represents causal links 308 between the nodes. As the first step, the edges with score 1 are removed, as it is determined that there is no causal responsibility between the two given nodes. Next, since a causal network 210 is a directed acyclic graph, the edges responsible for cycles in the CEGs are removed. Finally, the CEGs are removed which 1) do not have any remaining causal links 308 between the nodes, or 2) have depth <2 from the root node to the leaf node, in order to satisfy the requirement for a Markov-based split. After pre-processing, in this example, there are 764 CEGs remaining.

Regarding event extraction, the CLEVRER-Humans dataset contains 27 distinct events such as collide, enter, exit, halt, go, etc. These events may be subdivided into two categories: binary events and singular events. A binary event involves two participating objects, including events such as collide, bump, hit, bounce, sideswipe, etc. A singular event involves only a single participating object, including events such as enter, exit, stop, etc.

Information about the event type and participating objects may be extracted from the node descriptions in the CEG. This may be accomplished by parsing the CEG JSON files provided by the dataset. In an example, the Berkeley neural semantic parser and NLTK stem lemmatizer may be used to capture the root form of the event label, such as collide, hit, push, etc. instead of collided, hits, pushed, etc. The nodes that include a composition of multiple events, such as “The red ball collides with the blue sphere and hits the yellow cylinder” which consists of two events (i.e., collide and hit), are removed from the CEG. Instead, the nodes that describe a single event are considered for processing.

Regarding object and object property extraction, along with the event type, the participating objects and their characteristics are also extracted, such as color, shape, and material. There are some object characteristics that are mislabeled in the dataset, such as labeling an object color as gold rather than yellow. These mislabeling issues may be identified and the terms may be normalized.

A CausalKG 216 is generated from CLEVRER-Humans by encoding the causal information within the CEGs in RDF format, conformant with the causal ontology 218. In addition to causal relations 306, the KG contains information about events (such as hit, collide, push, etc.) along with the participating objects and their characteristics. The CEGs are graphical representations of events in the videos. Three ontologies 218 may be used to represent information from the CEGs: causal ontology, scene ontology (prefix so:), and semantic sensor network ontology 218 (prefix ssn:). The causal ontology 218 is used to represent the events (as causal entities), causal relations, and their associated causal weights (i.e., edge score). The scene ontology 218 and sensor ontology 218 are used to represent the additional information about the video, including scenes, objects, and object characteristics. Each video is represented as a scene (so: Scene) using concepts from the scene ontology 218. This includes representing and linking the events included in the scene (with the so: includes relation), the participating objects (with the so:hasParticipant relation), and the object characteristics (with the ssn:hasProperty relation). In total, the CausalKG from CLEVRER-Humans contains >48K links, 5664 entities, 31 entity types, and 10 relations.

Regarding splitting the data, a novel dataset splitting approach is introduced, that of the Markov-based split, grounded in the local Markov property of causal relations 306. For the evaluation, two different techniques are utilized for splitting the data into train and test sets: 1) random data split and 2) Markov-based data split. In the random data split, the links in the CausalKG 216 are randomly split into train, test, and validation sets following the 80:10:10 split ratio. Depending on which causal links 308 are selected for training and testing, this approach could lead to model bias. For example, given the CEG shown in FIG. 4, and considering the causal prediction query for event G (e.g., to predict the type of effect-entity), there are several causal links 308 that may provide relevant causal information.

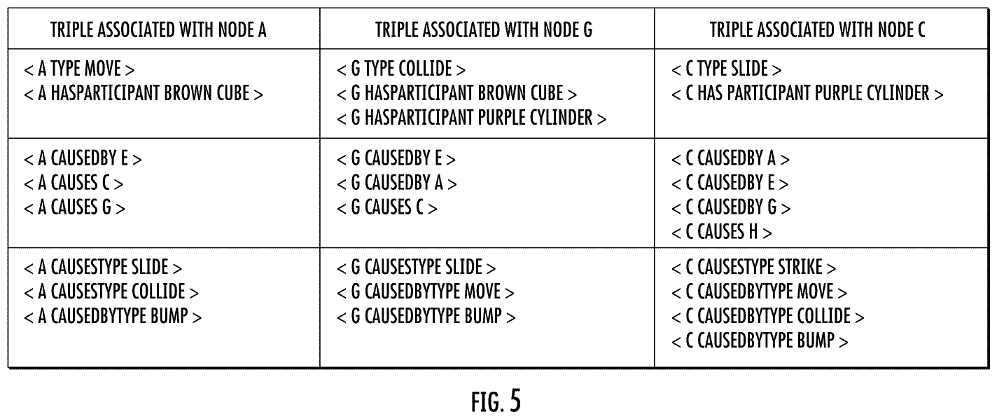

FIG. 5 illustrates an example table of causal links 308. This snapshot of causal links 308 are gleaned from the CLEVRER-Humans CausalKG 216. In particular, they are defined from nodes A, G, and C in the CEG illustrated in FIG. 4.

It should be noted that the causal link 308 <G, causesType, Slide> should not be included in training since this the link 308 to be predicted. Other relevant causal links 308 may also lead to model bias, such as <G, causes, C> and <C, causedBy, G>, and should not be in the training set. In general, any causal link 308 in the CausalKG 216 that spans across the Markov-based split line should not be used for training in order to minimize model bias which leads to inflated model performance.

To mitigate the above issue, an additional preprocessing step is introduced using the Markov-based data split before generating a CausalKG 216. With the Markov-based data split, the initial train and test sets contains 80% and 20% of the total CEGs, respectively. From the 764 CEGs, 612 are in train and 152 are in test set. Next, the CEGs in the test set are further split at depth 1 from the root node, as illustrated by the horizontal dotted line in FIG. 4. The split is based on the local Markov property of a causal network; meaning, for a given direct cause of a node, it is independent of its non-effects. The nodes and edges on either side of the horizontal dotted line are denoted as Markov-train and Markov-test sets, depending on the discovery task, e.g., either causal explanation or causal prediction. For the task of causal prediction, the nodes and relations in the upper half of the Markov-based split are included in the Markov-train set and the lower half in the Markov-test set, and vice-versa for causal explanation. Furthermore, causal links 308 spanning across the Markov-train and Markov-test sets, as shown by the arrows crossing the horizontal dotted line in FIG. 4, are masked and moved to the Markov-test set. The CEGs in the train set, along with the nodes and relations in Markov-train set, are used to generate the CausalKG 216 for CLEVRER-Humans which is then subsequently used for training the KG embeddings 224. The nodes and relations in the Markov-test are used to generate test links for evaluating the KG embeddings 224. The respective data splits are fed to the KGE algorithms to generate both CausalKGE-Base and CausalKGE-W embeddings 224A, 224B which will be used to for the link prediction task for causal explanation and prediction.

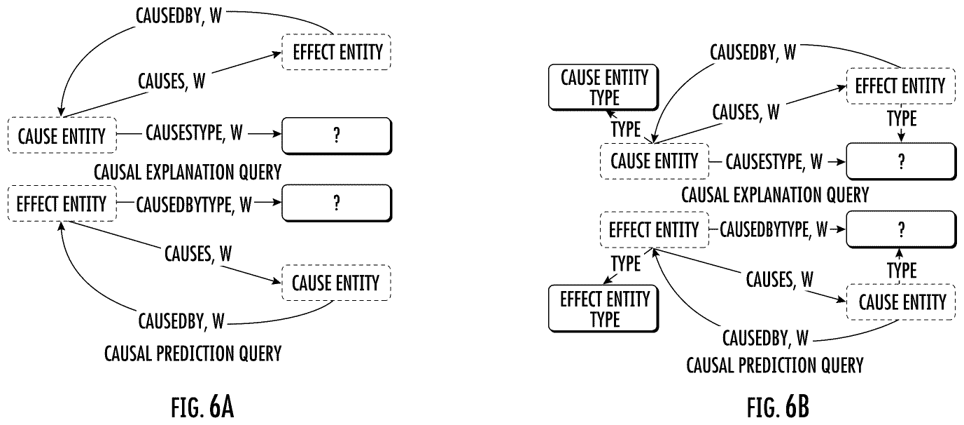

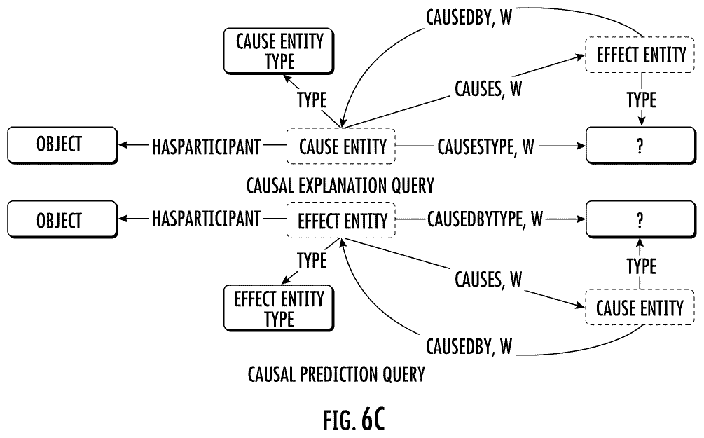

Regarding diversifying the available knowledge, the CausalKGE-Base and CasualKGE-W embeddings 224A, 224B are generated and evaluated on different CLEVRER-Humans CausalKG subgraph structures for the causal explanation and causal prediction tasks, as shown in FIGS. 6A-6C. Various graph structures are used in order to evaluate how the disclosed approach performs when different types of information are available in the CausalKG. Specifically, there are three distinct sub-graph structures defined with an increasing level of expressivity.

FIG. 6A illustrates an example CausalKG structure including a subgraph C with causal links 308 with only causal relations 306. These causal relations 306 may include, for example causes, causedBy, causesType, and causedByType. FIG. 6B illustrates an example CausalKG structure including a subgraph CT with causal links 308 with causal relations 306 and information about entity types. These entity types may include, for example rdf: type. FIG. 6C illustrates an example CausalKG structure including a subgraph CTP with causal relations 306, entity type relations, and information about the objects that participate in the causal events (e.g., has-Participant).

The hyper-parameters for each of the above graph structures are optimized for both causal explanation and prediction. The CausalKGE models are trained on their respective optimized hyper-parameters. The trained CausalKGEs are then used for causal discovery tasks using well established link prediction methods.

Regarding evaluation metrics, the disclosed approach is evaluated by following the KG link prediction experiment design. Given the set of causal links E_{c} in CausalKG 216, a set of corrupted links [symbol] ′ are generated by replacing the head h_{c} or tail t_{c} of a set of causal links, <h_{c}, r_{c}, t_{c}, w_{c}>, with another causal entity in the KG. Replacing the head with h′_{c}≠h_{c} results in <h′_{c}, r_{c}, t_{c}, w_{c}> or replacing the tail with t′_{c}≠t_{c} results in <h_{c}, r_{c}, t′_{c}, w_{c}>.

The model scores the true link <h_{c}, r_{c}, t_{c}, w_{c}> and corrupted links <h′_{c}, r_{c}, t_{c}, w_{c}>, <h_{c}, r_{c}, t′_{c}, w_{c}>∈ [symbol] ′. The scores are then sorted to obtain the rank of the true link. The filtered evaluation setting and filtered corrupted links [symbol] ′ are used to exclude the links present in the training and validation set. The overall performance of the models is measured using mean reciprocal rank (MRR) and Hits@k for k={1, 3, 10}. MRR is the mean over the reciprocal of individual ranks of test links. Hits@k is the ratio of test links present among the top k ranked links.

The disclosed approach may thus be evaluated for the causal explanation and prediction task, using the CausalKG generated from the CLEVRER-Humans dataset. Specifically, the disclosed approach has four trained KGE models:
CausalKGE-Base with random data split;
CausalKGE-Base with Markov-based data split;
CausalKGE-W with random data split; and
CasualKGE-W with Markov-based data split.

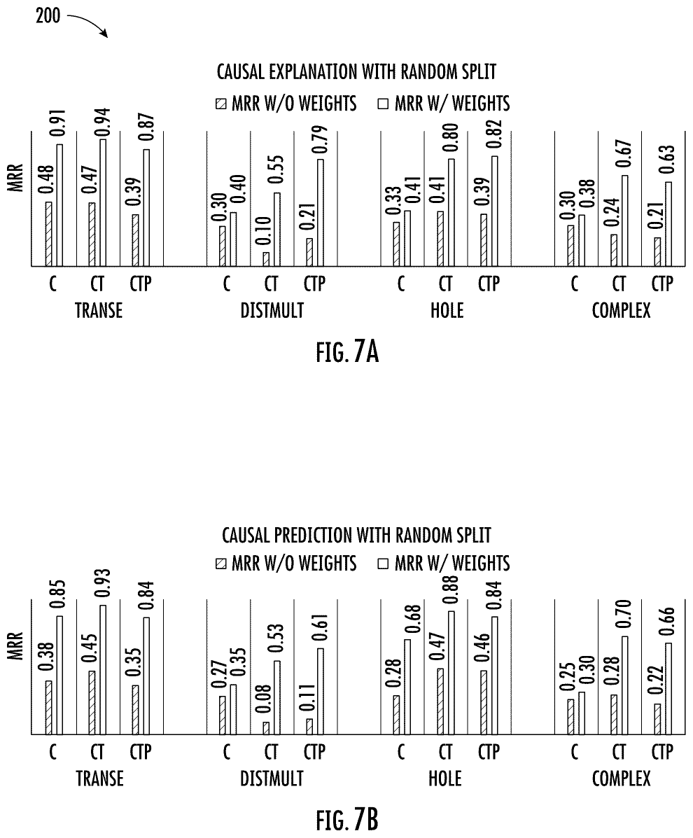

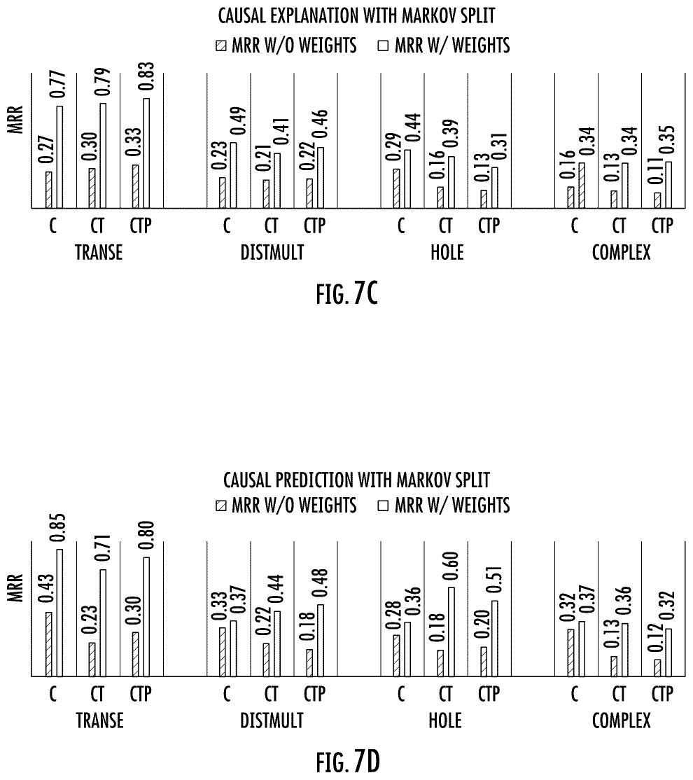

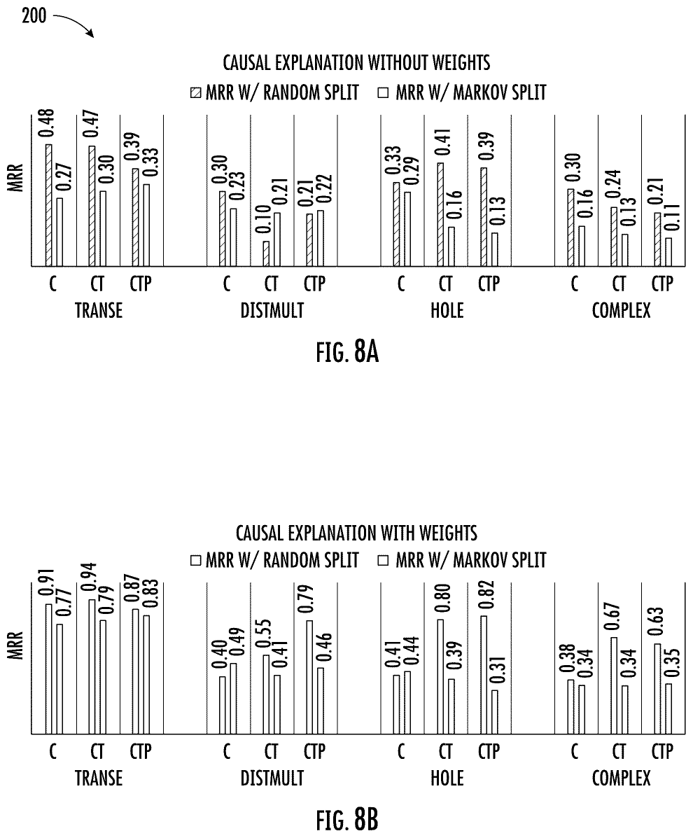

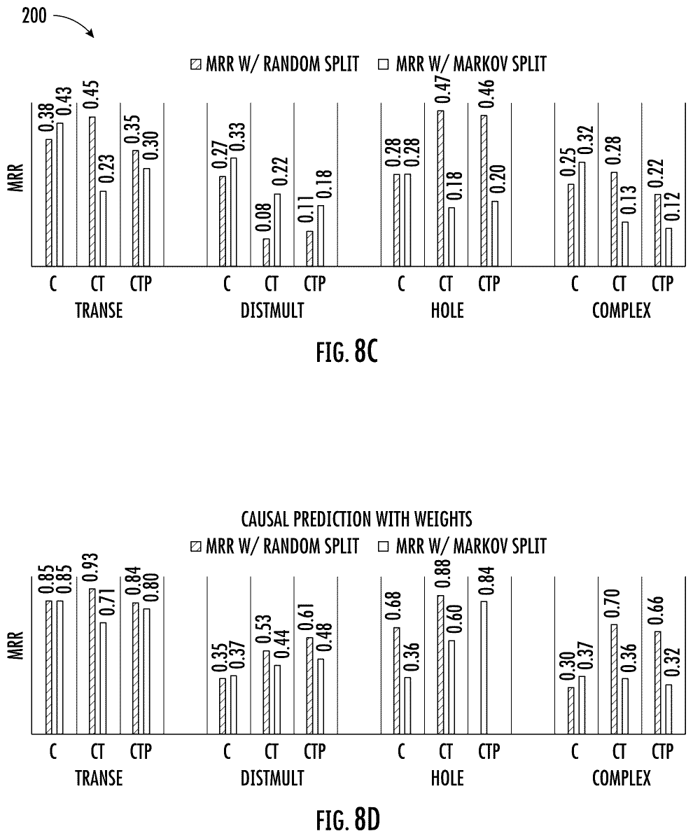

FIGS. 7A-7D and 8A-8D collectively illustrate the MRR scores for the four KGE models evaluated on different CausalKG 216 structures. This is shown using C structures having with causal links 308 with causal relations 306, using CT structures with causal links 308 having causal relations 306 and information about entity types, and using CTP structures having causal relations 306, entity type relations, and information about the objects that participate in the causal events.

FIGS. 7A-7D collectively illustrate evaluations of KGE models without causal weights (i.e. CausalKGE-Base) and with causal weights (i.e., CausalKGE-W) using different CausalKG structures and data split strategies (i.e., random-data split or Markov-based data split). FIG. 7A illustrates an example evaluation of CausalKGE-Base vs CausalKGE-W for causal explanation with a random data split. FIG. 7B illustrates an example evaluation of CausalKGE-Base vs CausalKGE-W for causal prediction with a random data split. FIG. 7C illustrates an example evaluation of CausalKGE-Base vs CausalKGE-W for causal explanation with a Markov-based data split. FIG. 7D illustrates an example evaluation of CausalKGE-Base vs CausalKGE-W for causal prediction with a Markov-based data split.

FIG. 8 collectively illustrate evaluations of KGE models without causal weights (i.e., CausalKGE-Base) and with causal weights (i.e., CausalKGE-W) using different CausalKG structures and data split strategies (i.e., random-data split or Markov-based data split). FIG. 8A illustrates an example evaluation of CausalKGE-Base for causal explanation with a random vs a Markov-based data split. FIG. 8B illustrates an example evaluation of CausalKGE-W for causal explanation with a random vs a Markov-based data split. FIG. 8C illustrates an example evaluation of CausalKGE-Base for causal prediction with a random vs a Markov-based data split. FIG. 8D illustrates an example evaluation of CausalKGE-Base for causal prediction with a random vs a Markov-based data split.

The MRR scores of CausalKGE-W for causal explanation and causal prediction using the random data split, on average across KGE models, outperforms CausalKGE-Base by 43.26% and 79.26% respectively. The MRR scores of CausalKGE-W for causal explanation and causal prediction using Markov-based data split, on average across KGE models, outperforms CausalKGE-Base by 115.05% and 38.96% respectively. The MRR scores of CausalKGE-W using random-based data split when enriched with additional knowledge for causal explanation, i.e., CTP, on average across KGE models, outperforms C by 33.49%. The MRR scores of CausalKGE-W using Markov-based data split for causal explanation, on average across KGE models, outperforms random data split by 0.75%. The MRR scores of CausalKGE-Base using Markov-based data split for causal prediction, on average across KGE models, outperforms random data split by 15.28%. The MRR scores of CausalKGE-W using random-based data split when enriched with additional knowledge for causal prediction,i.e., CTP, on average across KGE models, outperforms C by 28.65%.

Along with the MRR score, Hits@k is also estimated for K. The Hits@1, Hits@3 and Hits@10 of CausalKGE-W for causal explanation using random based split outperformed CausalKGE-Base by 37.28%, 31.10% and 68.2%, respectively. The Hits@1, Hits@3 and Hits@10 of CausalKGE-W for causal prediction using random based split outperformed CausalKGE-Base by 84.22%, 64.62%, and 80.57% respectively. The Hits@1, Hits@3 and Hits@10 of CausalKGE-W for causal prediction using Markov-based split outperformed CausalKGE-Base by 29.91%, 34.33%, and 36% respectively. The Hits@1 and Hist@10 of CausalKGE-Wfor causal explanation using Markov-based split outperformed CausalKGE-Base by 145.65% and 114.38% respectively.

Thus, the evaluation results show improved performance of the disclosed approach for causal prediction and causal explanation using CausalKGE-W. However, the disclosed approach for random-data split outperformed the Markov-based data split for both CausalKGE-Base and CausalKGE-W due to issues of data leakage and model bias. It is also evident that by adding knowledge to the CausalKG structure, the CausalKGE-W significantly outperform CausalKGE-Base for both random-based and Markov-based data splits.

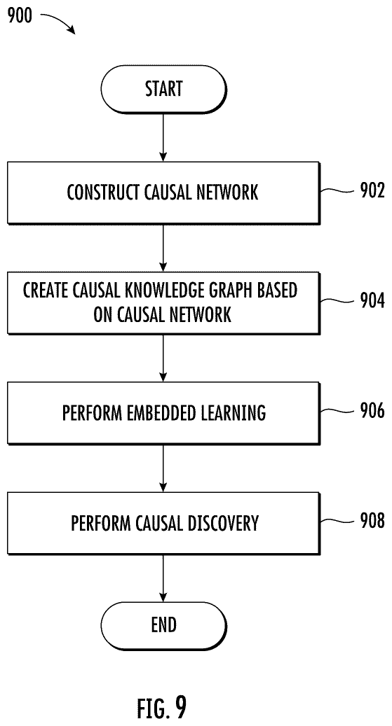

FIG. 9 illustrates an example process 900 for causal discovery using knowledge graph link prediction. The process 900 may be implement the disclosed approach to causal discovery using knowledge graph link prediction addresses a crucial gap in the state-of-the-art by considering causal weights 306 along with a causal links 308. Using the process 90, the KGE models trained with causal weights 306 may be seen to outperform baseline KGE metrics without causal weights 306. The results demonstrate that an effective fusion of causal links 308 with causal weights 306 in a KG can facilitate causal discovery through the completion of sparse KGs that may be missing critical causal relations.

At operation 902, causal network construction 202 is performed. The causal network construction 202 may include finding and encoding the known causal relations into a causal network 210. This causal network construction 202 may be performed using observational data 212 and/or using domain knowledge 214.

At operation 904, causal knowledge graph creation 204 is performed. The causal knowledge graph creation 204 may include translating the causal network 210 into a CausalKG 216, conformant to a causal ontology 218. The CausalKG 216 may include a plurality of causal links, each of the causal links 308 includes a cause entity, a causal relation, an effect entity, and a causal weight indicating a relative strength of causal influence of the cause entity on the effect entity. In an example, information from the causal network 210 may be translated into the CausalKG 216 according to a mapping. The mapping may include mapping causal weights 306 in the causal network 210 to causal weights 306 in the CausalKG 216. The mapping may also include mapping nodes in the causal network 210 into causal entities 302 in the CausalKG 216 and mapping edges in the causal network 210 into causal links 308 in the CausalKG 216. The mapping may also include removing causal links 308 from the CausalKG 216 having causal weights below a predefined minimum threshold of causal weight 306. In some examples, a CEG may be used as proxy for the causal network 210, and in such an example when translating the information into the CausalKG 216, any cycles in the CEG are removed.

To perform the learning, a Markov-based data split may be performed to divide the causal network 210 between train and test sets, such that causal links 308 spanning a depth greater than one node from a root node of the causal network 210 to a leaf node of the causal network 210 are included in the test set, not the train set.

At operation 906, embedding learning 206 is performed. The embedding learning 206 may include learning KG embedding models 220A, 220B for the CausalKG 216 using the train set, and evaluating the training using the test set. This may be performed in two different approaches. In a first approach, causal weights 306 from the causal network 210 are used in the embeddings 224A with causal weights 306 to generate embedding model 220A. In a second approach, the causal weights 306 from the causal network 210 are not used, resulting in embeddings 224B without causal weights 306 to generate embedding model 220B. In many examples, the application of the causal weights 306 from the causal network 210 outperforms baseline KGE metrics without causal weights 306.

At operation 908, causal discovery 208 is performed. The causal discovery 206 may include using the knowledge graph embeddings 224A, 224B for causal discovery tasks. One example of such a task is predicting new causal links 308 in the CausalKG 216. In some examples, the causal discovery 206 includes casual explanation to predict, given an effect entity, a type of a cause entity of the additional causal link. In some examples, the causal discovery 206 includes casual prediction to predict, given a cause entity, a type of an effect entity of the additional causal link. After operation 908, the process 900 ends.

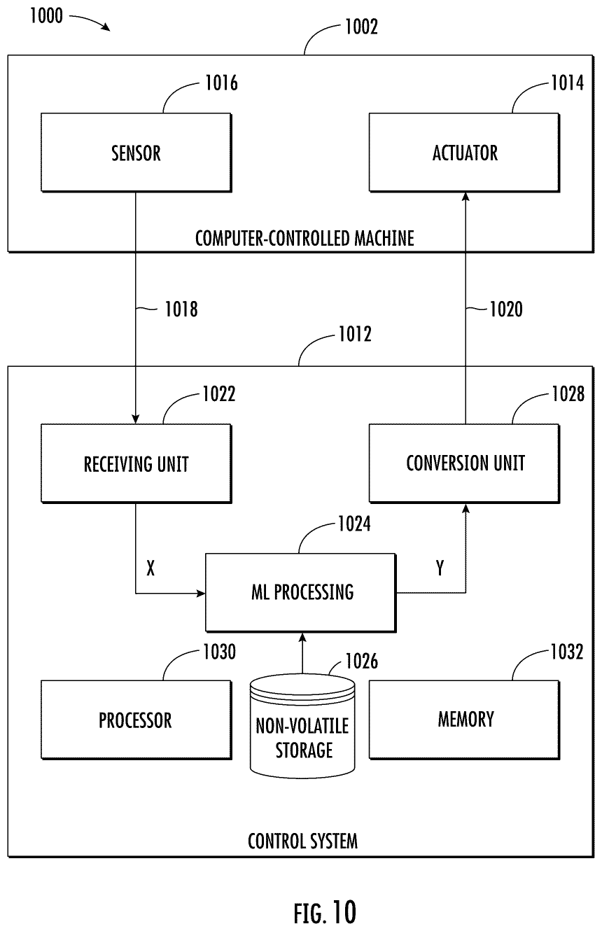

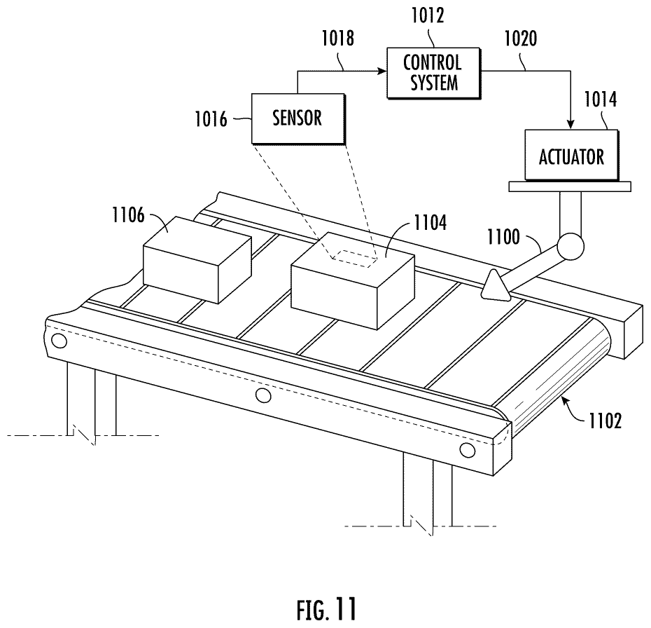

FIG. 10 depicts a schematic diagram of an interaction between a computer-controlled machine 1002 and a control system 1012. The computer-controlled machine 1000 may implement aspects of the causal discovery and use of the predicted causal information. Referring to FIG. 10, and with reference to FIGS. 1-9, the approaches discussed herein may be performed in the context of such a computer-controlled machine 1002 and control system 1012. The computer-controlled machine 1002 includes actuator 1014 and sensor 1016. Actuator 1014 may include one or more actuators and sensor 1016 may include one or more sensors. Sensor 1016 is configured to sense a condition of computer-controlled machine 1002. Sensor 1016 may be configured to encode the sensed condition into sensor signals 1018 and to transmit sensor signals 1018 to control system 1012. Non-limiting examples of sensor 1016 include video, radar, LiDAR, ultrasonic and motion sensors. In one embodiment, sensor 1016 is an optical sensor configured to sense optical images of an environment proximate to computer-controlled machine 1002.

Control system 1012 is configured to receive sensor signals 1018 from computer-controlled machine 1002. As set forth below, control system 1012 may be further configured to compute actuator control commands 1020 depending on the sensor signals and to transmit actuator control commands 1020 to actuator 1014 of computer-controlled machine 1002.

As shown in FIG. 10, control system 1012 includes receiving unit 1022. Receiving unit 1022 may be configured to receive sensor signals 1018 from sensor 1016 and to transform sensor signals 1018 into input signals X. In an alternative embodiment, sensor signals 1018 are received directly as input signals X without receiving unit 1022. Each input signal x may be a portion of each sensor signal 1018. Receiving unit 1022 may be configured to process each sensor signal 1018 to product each input signal x. Input signal x may include data corresponding to an image recorded by sensor 1016.

Control system 1012 includes machine learning (ML) processing 1024. ML processing 1024 may be configured to learn, classify, infer, generate, etc. using one or more models such as those described in detail above. In an example, ML processing 1024 is configured to determine output signals Y from input signals X. Each output signal y includes information that assigns one or more labels to each input signal X. ML processing 1024 may transmit output signals Y to conversion unit 1028. Conversion unit 1028 is configured to convert output signals Y into actuator control commands 1020. Control system 1012 is configured to transmit actuator control commands 1020 to actuator 1014, which is configured to actuate computer-controlled machine 1002 in response to actuator control commands 1020. In another embodiment, actuator 1014 is configured to actuate computer-controlled machine 1002 based directly on output signals Y.

Upon receipt of actuator control commands 1020 by actuator 1014, actuator 1014 is configured to execute an action corresponding to the related actuator control command 1020. Actuator 1014 may include a control logic configured to transform actuator control commands 1020 into a second actuator control command, which is utilized to control actuator 1014. In one or more embodiments, actuator control commands 1020 may be utilized to control a display instead of or in addition to an actuator.

In another embodiment, control system 1012 includes sensor 1016 instead of or in addition to computer-controlled machine 1002 including sensor 1016. Control system 1012 may also include actuator 1014 instead of or in addition to computer-controlled machine 1002 including actuator 1014.

As shown in FIG.10, control system 1012 also includes processor 1030 and memory 1032. Processor 1030 may include one or more processors. Memory 1032 may include one or more memory devices. The classifier 1024 (e.g., ML algorithms) of one or more embodiments may be implemented by control system 1012, which includes non-volatile storage 1026, processor 1030 and memory 1032.

Non-volatile storage 1026 may include one or more persistent data storage devices such as a hard drive, optical drive, tape drive, non-volatile solid-state device, cloud storage or any other device capable of persistently storing information. Processor 1030 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 1032. Memory 1032 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 1030 may be configured to read into memory 1032 and execute computer-executable instructions residing in non-volatile storage 1026 and embodying one or more ML algorithms and/or methodologies of one or more embodiments. Non-volatile storage 1026 may include one or more operating systems and applications. Non-volatile storage 1026 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 1030, the computer-executable instructions of non-volatile storage 1026 may cause control system 1012 to implement one or more of the ML algorithms and/or methodologies as disclosed herein. Non-volatile storage 1026 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 11 illustrates an example manufacturing system 1100 for use in anomaly detection and/or generation of synthetic anomalous data. The system 1100 may be configured to control a manufacturing machine 1102, such as a punch cutter, a cutter or a gun drill, etc., such as part of a production line.

The system 1100 may be configured to control an actuator 1014, which is configured to control the manufacturing machine 1102. A sensor 1016 of the system 1100 may be configured to capture one or more properties of a manufactured product 1104. ML processing 1024 may be configured to determine a state of the manufactured product 1104 from one or more of the captured properties. An actuator 1014 may be configured to control the system 1100 (e.g., a manufacturing machine) depending on the determined state of the manufactured product 1104 for a subsequent manufacturing step of the manufactured product 1104. In particular, the actuator 1014 may be configured to control functions of system 1100 (e.g., the manufacturing machine) on subsequent manufactured product 1106 of the system 1100 (e.g., the manufacturing machine) depending on the determined state of the manufactured product 1104.

For example, the system 1100 may utilize the CausalKG 216 to predict reasons for issues in the manufacturing system 1100, such as what issued was causedBy. Or, the system 1100 may utilize the CausalKG 216 to predict outcomes that should be addressed, such as that sensed input may cause an issue, e.g., causesType.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for causal discovery using knowledge graph link prediction, comprising:
translating information from a causal network into a causal knowledge graph according to a mapping, the causal knowledge graph comprising a plurality of causal links, wherein each of the causal links includes a cause entity, a causal relation, an effect entity, and a causal weight indicating a relative strength of causal influence of the cause entity on the effect entity;
converting the causal knowledge graph into embeddings, the embeddings comprising a latent vector space representation of the causal knowledge graph;
training the embeddings using a subset of the causal links of the causal knowledge graph; and
using the embeddings for causal discovery to predict additional causal links of the causal knowledge graph.

2. The method of claim 1, wherein the mapping includes mapping causal weights in the causal network to causal weights in the causal knowledge graph.

3. The method of claim 1, wherein the translating is performed conformant to a causal ontology, the causal ontology defining concepts to structure the causal knowledge graph.

4. The method of claim 1, wherein the mapping further includes:
mapping nodes in the causal network into causal entities in the causal knowledge graph; and
mapping edges in the causal network into causal links in the causal knowledge graph.

5. The method of claim 4, further comprising removing causal links from the causal knowledge graph having causal weights below a predefined minimum threshold of causal weight.

6. The method of claim 1, wherein a causal event graph is used as proxy for the causal network, and further comprising, when translating the information into the causal knowledge graph, removing cycles from the causal event graph.

7. The method of claim 1, wherein the causal knowledge graph has a depth of greater than or equal to two nodes from root to leaf node, and further comprising performing a Markov-based data split between the train and test sets further comprising performing a Markov-based data split between the train and test sets.

8. The method of claim 1, wherein the causal discovery includes casual explanation to predict, given an effect entity, a type of a cause entity of the additional causal link.

9. The method of claim 1, wherein the causal discovery includes casual prediction to predict, given a cause entity, a type of an effect entity of the additional causal link.

10. A system for causal discovery using knowledge graph link prediction, comprising:
one or more hardware computing devices configured to:
translate information from a causal network into a causal knowledge graph according to a mapping, the causal knowledge graph comprising a plurality of causal links, wherein each causal link includes a cause entity, a causal relation, an effect entity, and a causal weight indicating a relative strength of causal influence of the cause entity on the effect entity;
convert the causal knowledge graph into embeddings, the embeddings comprising a latent vector space representation of the causal knowledge graph;
train the embeddings using a subset of the causal links of the causal knowledge graph; and
use the embeddings for causal discovery to predict additional causal links of the causal knowledge graph.

11. The system of claim 10, wherein the mapping includes mapping causal weights in the causal network to causal weights in the causal knowledge graph.

12. The system of claim 10, wherein the translating is performed conformant to a causal ontology, the causal ontology defining concepts to structure the causal knowledge graph.

13. The system of claim 10, wherein the one or more hardware computing devices are further configured to:
map nodes in the causal network into causal entities in the causal knowledge graph; and
map edges in the causal network into causal links in the causal knowledge graph.

14. The system of claim 13, wherein the one or more hardware computing devices are further configured to remove causal links from the causal knowledge graph having causal weights below a predefined minimum threshold of causal weight.

15. The system of claim 10, wherein a causal event graph is used as proxy for the causal network, and further comprising, when translating the information into the causal knowledge graph, removing cycles from the causal event graph.

16. The system of claim 10, wherein the causal knowledge graph has a depth of greater than or equal to two nodes from root to leaf node, and the one or more hardware computing devices are further configured to perform a Markov-based data split between the train and test sets.

17. The system of claim 10, wherein the causal discovery includes casual explanation to predict, given an effect entity, a type of a cause entity of the additional causal link.

18. The system of claim 10, wherein the causal discovery includes casual prediction to predict, given a cause entity, a type of an effect entity of the additional causal link.

19. A non-transitory computer-readable medium comprising instructions for causal discovery using knowledge graph link prediction that, when executed by one or more computing devices, cause the one or more computing devices to perform operations including to:
translate information from a causal network into a causal knowledge graph according to a mapping, the causal knowledge graph comprising a plurality of causal links, wherein each causal link includes a cause entity, a causal relation, an effect entity, and a causal weight indicating a relative strength of causal influence of the cause entity on the effect entity, the mapping including mapping causal weights in the causal network to causal weights in the causal knowledge graph;
convert the causal knowledge graph into embeddings, the embeddings comprising a latent vector space representation of the causal knowledge graph;
train the embeddings using a subset of the causal links of the causal knowledge graph; and
use the embeddings for causal discovery to predict additional causal links of the causal knowledge graph.

20. The medium of claim 1, wherein the causal discovery includes one or more of:
casual explanation to predict, given an effect entity, a type of a cause entity of the additional causal link; and
causal discovery includes casual prediction to predict, given a cause entity, a type of an effect entity of the additional causal link.
